(19) United States
(12) Patent Application Publication
(10) Pub. No.: US 2013/0287520 A1
(43) Pub. Date: Oct. 31, 2013

(54) Coupling arrangement for providing controlled loading

(71) Applicants: Aaron L. Hartzler, Lafayette, IN (US); Lucian Stanciu, Dayton, IN (US)

(72) Inventors: Aaron L. Hartzler, Lafayette, IN (US); Lucian Stanciu, Dayton, IN (US)

(73) Assignee: CATERPILLAR INC., Peoria, IL (US)

(21) Appl. No.: 13/457,139

(22) Filed: Apr. 26, 2012

(51) Int. Cl. F16B 21/00; B23P 11/00

(52) U.S. Cl. 411/347; 29/525.01

(57) ABSTRACT

Arrangement for coupling first component and a second component exhibiting thermal expansion. The shank of a fastener extends through the first opening of a flattened first spacer, a spring opening of a spring element, and a second opening of a second spacer element, and is fixedly secured to the first component. The second spacer is disposed within a channel in the second component. The first spacer is disposed subjacent a head of the fastener, and the spring element is disposed between the first spacer and an abutment surface of the second component.

### TECHNICAL FIELD

This patent disclosure relates generally to arrangements utilized to couple one component to another, and, more particularly to a coupling arrangement for coupling components wherein one of the component exhibits thermal expansion.

### BACKGROUND

In some machine applications, one or more components may exhibit thermal expansion under normal, excessive, or high power use. For example, exhaust components may exhibit thermal expansion under normal operating temperatures. Thermal expansion of components may also be exhibited or enhanced when machines are utilized in high or low temperature environments or at high or low altitudes. Despite the thermal expansion of one or more components, it may still be desirable to maintain the relative positions of an expanding component to nonexpanding components. This may be particularly true in conditions where there is significant vibration. Under such conditions, coupling arrangements may be subject to high stresses due to the resulting repeated impacts, subjecting coupling arrangements to the threat of fatigue or failure.

U.S. Pat. No. 7,258,541 to Novo discloses a thermal expansion compensation support that includes a bolt extending through a block member partially disposed within a spring member having a skirt portion that extends about a finger portion of the block member. Under repeated impacts, however, the coupling may be susceptible to fatigue and failure, particularly with regard to the skirt portion, which acts as a spring to absorb relative movement.

### SUMMARY

The disclosure describes, in one aspect, an arrangement for coupling first and second components wherein the second component exhibits thermal expansion. The second component presents an abutment surface and has a channel therethrough. The arrangement includes a fastener, a flattened first spacer, an elongated second spacer, and a spring element. The fastener has a head and a shank. The shank extends through the channel of the second component and fixedly engages the first component. The flattened first spacer has a first opening extending therethrough, and is disposed substantially subjacent the head with the shank extending through the first opening. The elongated second spacer has first and second ends, a second opening extending therethrough from the first end to the second end, and a substantially annular first outer surface. The second spacer is disposed between the first spacer and the first component with the shank extending through the second opening. The first end has a surface abutting the first component. The spring element defines a spring opening therethrough, and is disposed between the first spacer and the abutment surface about the first outer surface of the second spacer.

The disclosure describes, in another aspect, a coupling arrangement including a first component, a second component adapted to exhibit thermal expansion, a fastener, a flattened first spacer, an elongated second spacer, and a spring element. The second component includes an abutment surface and has a channel therethrough. The fastener has a head and a shank. The shank extends through the channel of the second component and fixedly engages the first component. The flattened first spacer has a first opening extending therethrough, and is disposed substantially subjacent the head with the shank extending through the first opening. The elongated second spacer has first and second ends, a second opening extending therethrough from the first end to the second end, and a substantially annular first outer surface. The second spacer is disposed between the first spacer and the first component with the shank extending through the second opening, the first end of the second spacer abutting the first component. The spring element defines a spring opening therethrough. The spring element is disposed between the first spacer and the abutment surface about the first outer surface, the spring element being adapted to allow thermal expansion of the second component relative to the first component.

The disclosure describes, in yet another aspect, a method of coupling a first component to a second component is adapted to exhibit thermal expansion. The method includes the steps of inserting a shank of a fastener through a first opening in a flattened first spacer to dispose the first spacer substantially subjacent a head of the fastener, inserting the shank of the fastener through a spring opening in a spring element, inserting the shank of the fastener through a second opening in an elongated second spacer, inserting a substantially annular first outer surface of the second spacer into the spring opening in the spring element, positioning the second spacer within a channel in the second component, and fixedly engaging the shank of the fastener with the first component to dispose the first spacer abutting an underside of the head of the fastener and the second spacer, the second spacer abutting the first spacer and the first component, and the spring element abutting the first spacer and the second component.

### BRIEF DESCRIPTION OF THE DRAWING(S)

FIG. 1 is a side elevational view of a machine including a coupling arrangement according to aspects of the disclosure.

FIG. 2 is an enlarged side elevation cross-sectional view of a coupling arrangement according to aspects of the disclosure.

FIG. 3 is an enlarged side elevation cross-sectional view of the coupling arrangement of FIG. 2 wherein the second component has exhibited thermal expansion.

FIG. 4 is an enlarged side elevation cross-sectional view of the coupling arrangement of FIG. 2, taken in a direction perpendicular to the direction illustrated in FIGS. 2 and 3.

### DETAILED DESCRIPTION

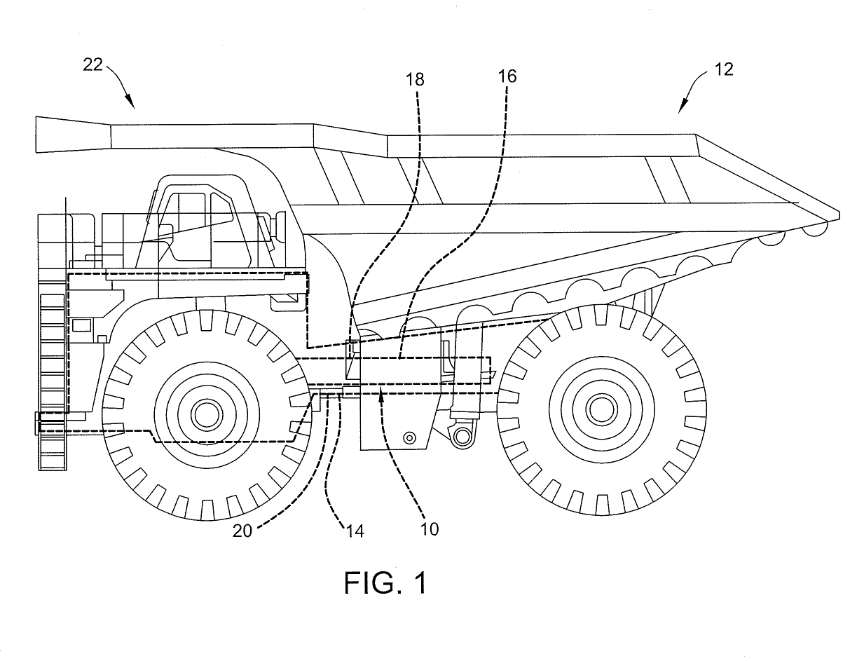

This disclosure relates to a coupling arrangement 10 for a machine 12 wherein first and second components 14, 16 must be substantially firmly coupled together in a first direction, but the second component 16 must be permitted to exhibit thermal expansion in a second direction. The arrangement 10 may be particularly useful, for example, in coupling components in aftertreatment exhaust system 18 to a frame element 20 in heavy duty trucks; such as the off-highway truck 22 illustrated in FIG. 1. While the arrangement 10 is illustrated in connection with an off-highway truck 22, the arrangement 10 disclosed herein has universal applicability in various other types of mobile machines 12 and stationary applications as well. The term “machine” may refer to any machine 12 that performs some type of operation associated with an industry such as mining, construction, farming, transportation, electric power generation or any other industry known in the art.

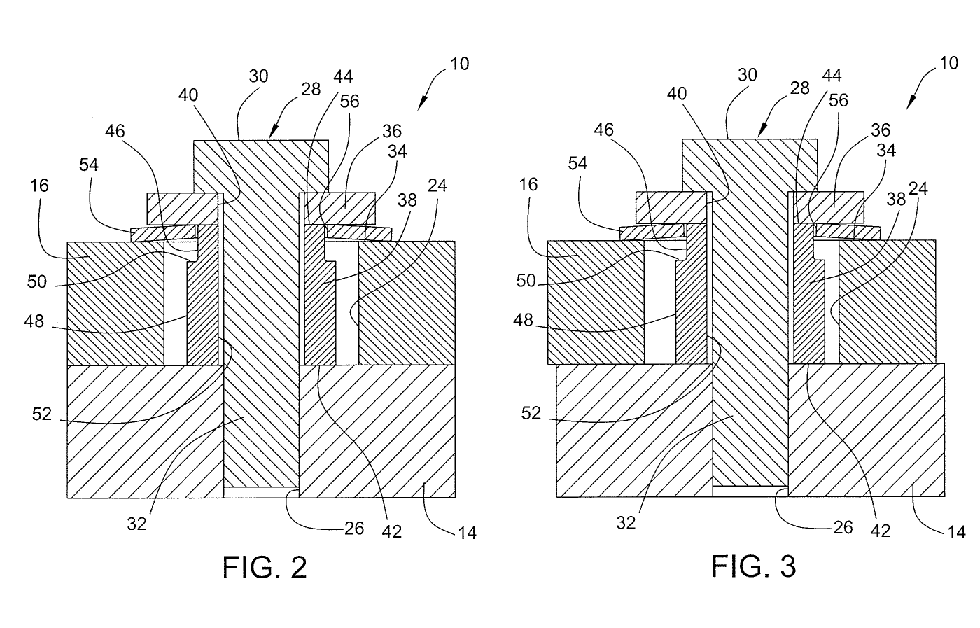

Turning to FIGS. 2 and 3, the arrangement 10 for coupling first and second components 14, 16 is illustrated in greater detail. In the illustrated embodiment, the second component 16 may exhibit thermal expansion under certain temperature or operating conditions. It will be noted that both components 14, 16 may exhibit thermal expansion in a given application. The disclosed coupling arrangement 10 is particularly applicable where the components 14, 16 exhibit different thermal expansions, for example, due to differential heating or different material compositions.

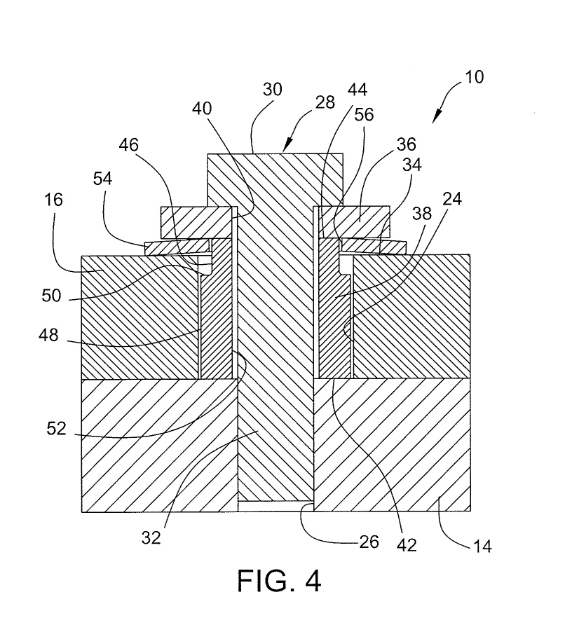

FIG. 2 shows the arrangement 10 in an unexpanded condition, while FIG. 3 shows the arrangement 10 with the second component 16 in an expanded condition. FIG. 4 shows a cross-section of the coupling arrangement 10 taken in a plane substantially perpendicular to the plane illustrated in FIGS. 2 and 3, FIG. 4 illustrating the arrangement 10 in both the expanded and unexpanded condition. It will be observed that the coupling arrangement 10 allows the second component 16 to shift in a direction during expansion, as illustrated in FIG. 3. In contrast, as shown in FIG. 4, regardless of expansion, the second component 16 is held in substantially the same relative position in a direction perpendicular to that illustrated in FIGS. 2 and 3.

The second component 16 includes a channel 24 therethrough, while the first component 14 includes a proximally located recess or bore 26. In order to couple the first and second components 14, 16 together, a fastener 28 having a head 30 and a shank 32 is provided. In use, the shank 32 of the fastener 28 extends through the channel 24 of the second component 16 and fixedly engages the recess or bore 26 of the first component 14. The second component 16 includes an abutment surface 34 opposite the first component 14, the significance of which will become apparent upon further explanation herein.

The arrangement 10 further includes first and second spacers 36, 38. The first spacer 36 has a flattened structure and includes a first opening 40. The second spacer 38 is an elongated structure with first and second ends 42, 44, the distance between the first and second ends 42, 44 representing the height of the second spacer 38. The second spacer 38 of the illustrated embodiment includes substantially annular first and second outer surfaces 46, 48 forming a shoulder 50 therebetween. The first outer surface 46 has a first diameter, and the second outer surface 48 includes a second diameter, the second diameter being greater than the first diameter. This difference between the diameters of the first and second outer surfaces 46, 48 provides a significant function in allowing thermal expansion of the arrangement 10 as discussed in detail below. A second opening 52 extends through the second spacer 38 between the first and second ends 42, 44. Although the first and second spacers 36, 38 are illustrated as separate components, it will be appreciated that they could alternately be formed as a single unit.

As may be seen in FIGS. 2 and 3, in use, the first spacer 36 is disposed subjacent the head 30 of the fastener 28, and the second spacer 38 is disposed substantially within the channel 24 of the second component 16. The shank 32 of the fastener 28 extends from the head 30 through the first and second openings 40, 52, and into the first component 14 to couple the first and second components 14, 16. The first end 42 of the elongated second spacer 38 includes a surface that abuts the first component 14, while at least a portion of the second end 44 of the elongated spacer abuts the first spacer 36.

In order to allow thermal expansion of the second component 16, the arrangement 10 also includes a spring element 54, which includes a spring opening 56 therethrough. In assembly, the spring element 54 is disposed between the first spacer 36 and the abutment surface 34 of the second component 16 about the first outer surface 46 of the second spacer 38. It will be appreciated that the compression, and, therefore, the load, on the spring element 54 may be controlled based upon the height of the second spacer 38 relative to the abutment surface 34 of the second component 16.

Thus, in construction, the shank 32 of the fastener 28 is inserted through the first opening 40 in the flattened first spacer 36 to dispose the first spacer 36 substantially subjacent the head 30 of the fastener 28. The shank 32 of the fastener 28 is further inserted through the spring opening 56 in the spring element 54, and the second opening 52 in the elongated second spacer 38. The elongated second spacer 38 is positioned within the channel 24 in the second component 16. After assembly, the shank 32 of the fastener 28 is fixedly engaged with the first component 14 to dispose the first spacer 36 abutting an underside of the head 30 of the fastener 28 and the second spacer 38, the second spacer 38 abutting the first spacer 36 and the first component 14, and the spring element 54 abutting the first spacer 36 and the second component 16. While the assembly has been described in a given order, it will be appreciated that the order can be other than as described, so long as the final arrangement 10 includes the first spacer 36 disposed subjacent the head 30 of the fastener 28, the spring element 54 disposed subjacent the first spacer 36 about the second spacer 38 and abutting the abutment surface 34 of the second component 16, with the shank 32 of the fastener 28 fixedly engaged with the first component 14.

In use, as the second component 16 expands, the arrangement 10 allows the second component 16 to shift and move and in a direction, as shown in FIG. 3. It will be appreciated, however, that the varied outer diameter of the second spacer 38 may limit the movement of the second component 16 in a perpendicular direction, as shown in FIG. 4. In other words, the outer diameter 48 may limit the movement of the second component 16 in the side to side direction as shown in FIG. 4, while allowing movement due to expansion in a side to side direction as shown in FIGS. 2 and 3. In this way, the second spacer 38 may be constructed to permit the desired relative movement of the second component 16 relative to the first component 14.

The first and second spacers 36, 38 as well as the spring element 54 may be formed of any appropriate support material, so long as the materials and structures will withstand the applied forces and environmental temperatures, and still perform their respective functions. The spring element 54 and the second spacer 38, for example, in some applications must withstand relatively high temperatures, as for example when utilized in aftertreatment exhaust systems 18. In the same application, however, the first spacer 36 may not need to withstand the same high temperatures inasmuch as the first spacer 36 is not necessarily in the same proximity to the excessive temperatures. The spring element 54 must also exhibit resilience during expansion of the second component 16. In this way, the spring element 54 allows some movement as a result of expansion of the second component 16, while facilitating the maintenance of the general relative positions of the first component 14 and the first and second spacers 36, 38. The spring element 54 may be, for example, a spring washer, also referred to as a Belleville washer, and formed of a material such as, by way of example only, a 17.7 precipitation hardened stainless steel. The second spacer 38, by way of example only, may be formed of a stainless steel material such as ASTM A193, which will withstand high temperatures while exhibiting the required strength.

While the first spacer 36 may have any appropriate shape and be formed of any appropriate material, so long as it provides required support for the spring element 54 as it flexes during expansion and movement of the second component 16. The first spacer 36 may be, for example, a washer shape. The first spacer 36, however, may not necessarily require the same heat resistance as the second spacer 38. Thus, it may be made of a hardened steel, but not necessarily of the same grade as the second spacer 38. An appropriate material may be, for example, a hot or cold finished steel with a maximum content of 0.55% carbon, 0.04% magnesium, and 0.05% sulfur, hardened to Rockwell C36-42.

### Industrial Applicability

The present disclosure is applicable to the coupling arrangements 10 wherein a coupled component 16 is subject to thermal expansion. The coupling arrangement 10 may allow relative movement between two components 14, 16 in one direction, while inhibiting movement in a perpendicular direction.

The coupling arrangement 10 may be particularly useful in machines 10 that are operated in relatively high or low temperature environments. Moreover, the coupling arrangement 10 may be particularly useful in applications wherein space is limited.

In some machine applications, one or more components may exhibit unequal thermal expansion. Thermal expansion may occur as a result of the normal operation of a component, or under excessive or high power use. Operation of aftertreatment exhaust systems 18, for example, may expose one or more components 16 to particularly high temperatures, while nearby components 14, such as a machine frame element 20, may experience substantially lower direct temperatures. Moreover, the structure and materials of the various components may result in varied thermal expansion between components. This effect may also be exhibited or enhanced when machines are utilized in high or low temperature environments or at high or low altitudes.

The arrangement 10 of this disclosure may be useful in such structures where it may still be desirable to maintain the relative positions of an expanding component 16 to nonexpanding components 14. This may be particularly true in conditions where there is significant vibration, as may be experienced in a mobile machine 12 or when a machine 12 is utilized at high load levels. Under such conditions, coupling arrangements may be subject to high stresses due to the resulting repeated impacts, subjecting coupling arrangements to the threat of fatigue or failure.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. An arrangement for coupling first and second components wherein the second component presents an abutment surface and having a channel therethrough and is adapted to exhibit thermal expansion, the arrangement comprising:
a fastener having a head and a shank, the shank extending through the channel of the second component and fixedly engaging the first component,
a flattened first spacer having a first opening extending therethrough, the first spacer being disposed substantially subjacent the head with the shank extending through the first opening,
an elongated second spacer having first and second ends, a second opening extending therethrough from the first end to the second end, and a substantially annular first outer surface, the second spacer being disposed between the first spacer and the first component with the shank extending through the second opening, the first end having a surface abutting the first component, and
a spring element defining a spring opening therethrough, the spring element being disposed between the first spacer and the abutment surface about the first outer surface of the second spacer.

2. The arrangement of claim 1 wherein the first and second spacers are formed as a single unit.

3. The arrangement of claim 1 wherein the first outer surface of the second spacer has a first diameter, and the second spacer includes a substantially annular second outer surface having a second diameter, the second diameter being larger than the first diameter.

4. The arrangement of claim 3 wherein the second outer surface allows movement of the second component relative to the first component in a first direction, and inhibits movement of the second component relative to the first component in a second direction, the second direction being substantially perpendicular to the first direction.

5. The arrangement of claim 4 wherein the first spacer has the shape of a washer, and the spring element is a spring washer disposed about the first outer surface, the spring washer having an inner diameter greater than the first diameter and less than the second diameter.

6. The arrangement of claim 1 wherein the first spacer is a hard washer.

7. The arrangement of claim 1 wherein the spring element is a spring washer.

8. The arrangement of claim 1 wherein the first component is part of an aftertreatment exhaust system.

9. A coupling arrangement comprising:
a first component,
a second component, the second component including an abutment surface and having a channel therethrough, the second component being adapted to exhibit thermal expansion,
a fastener having a head and a shank, the shank extending through the channel of the second component and fixedly engaging the first component,
a flattened first spacer having a first opening extending therethrough, the first spacer being disposed substantially subjacent the head with the shank extending through the first opening,
an elongated second spacer having first and second ends, a second opening extending therethrough from the first end to the second end, and a substantially annular first outer surface, the second spacer being disposed between the first spacer and the first component with the shank extending through the second opening, the first end of the second spacer abutting the first component, and
a spring element defining a spring opening therethrough, the spring element being disposed between the first spacer and the abutment surface about the first outer surface, the spring element being adapted to allow thermal expansion of the second component relative to the first component.

10. The arrangement of claim 9 wherein the first and second spacers are formed as a single unit.

11. The arrangement of claim 9 wherein the first outer surface of the second spacer has a first diameter, and the second spacer includes a substantially annular second outer surface having a second diameter, the second diameter being larger than the first diameter.

12. The arrangement of claim 11 wherein the second spacer includes a shoulder between the substantially annular first and second surfaces.

13. The arrangement of claim 12 wherein the first spacer is a hard washer, and the spring element is a spring washer.

14. The arrangement of claim 9 wherein the first spacer is a hard washer.

15. The arrangement of claim 9 wherein the spring element is a spring washer.

16. The arrangement of claim 9 wherein the first component is part of an aftertreatment exhaust system 18.

17. A method of coupling a first component to a second component is adapted to exhibit thermal expansion, the method comprising the steps of
inserting a shank of a fastener through a first opening in a flattened first spacer to dispose the first spacer substantially subjacent a head of the fastener,
inserting the shank of the fastener through a spring opening in a spring element,
inserting the shank of the fastener through a second opening in an elongated second spacer,
inserting a substantially annular first outer surface of the second spacer into the spring opening in the spring element,
positioning the second spacer within a channel in the second component, and
fixedly engaging the shank of the fastener with the first component to dispose the first spacer abutting an underside of the head of the fastener and the second spacer, the second spacer abutting the first spacer and the first component, and the spring element abutting the first spacer and the second component.

18. The method of claim 18 wherein the first outer surface of the second spacer has a first diameter, and the second spacer includes a shoulder and a substantially annular second outer surface having a second diameter, the second diameter being larger than the first diameter, the shoulder being disposed between the substantially annular first and second surfaces.

19. The method of claim 18 wherein the first spacer is a hard washer, and the spring element is a spring washer.

20. The method of claim 17 wherein the first spacer is a hard washer, and the spring element is a spring washer.
